(19) United States
(12) Patent Application Publication
(10) Pub. No.: US 2025/0002381 A1
(43) Pub. Date: Jan. 2, 2025

(54) PREPARATION METHOD AND USE OF NOVEL COPPER-METAL ORGANIC FRAMEWORK (CU-MOF)-DERIVED MAGNETIC Fe3O4@Cu/C COMPOSITE FOR ANTIBIOTIC DEGRADATION

(71) Applicant: Nanjing institute of Environmental Sciences, MEE, Nanjing City (CN)

(72) Inventors: Rong ZHOU, Nanjing City (CN); Yue YU, Nanjing City (CN); Hua Wu, Nanjing City (CN); Yuanqing Bu, Nanjing City (CN); Houhu Zhang, Nanjing City (CN); Shenghu Zhang, Nanjing City (CN); Chibin Zhang, Nanjing City (CN); Na Zhao, Nanjing City (CN)

(21) Appl. No.: 18/670,549

(22) Filed: May 21, 2024

(30) Foreign Application Priority Data
Jun. 27, 2023 (CN) 202310762888.1

(51) Int. Cl. C02F 1/72; B01J 21/18; B01J 23/72; B01J 23/745; B01J 35/33; B01J 37/00; B01J 37/04; B01J 37/08; C02F 101/34; C07F 1/08

(52) U.S. Cl. CPC C02F 1/725; B01J 21/18; B01J 23/72; B01J 23/745; B01J 35/33; B01J 37/0036; B01J 37/04; B01J 37/086; C02F 1/722; C07F 1/08; C02F 2101/34; C02F 2305/026

(57) ABSTRACT

Provided are a preparation method and use of a novel copper-metal organic framework (Cu-MOF)-derived magnetic Fe₃O₄@Cu/C composite for antibiotic degradation. The preparation method of the composite includes: compounding a novel Cu-MOF material obtained in a high-pressure reactor with Fe₂O₃, and then conducting calcination under an inert gas atmosphere to obtain the magnetic Fe₃O₄@Cu/C composite.

### CROSS-REFERENCE TO RELATED APPLICATION

This patent application claims the benefit and priority of Chinese Patent Application No. 202310762888.1 filed with the China National Intellectual Property Administration on Jun. 27, 2023, the disclosure of which is incorporated by reference herein in its entirety as part of the present application.

### TECHNICAL FIELD

The present disclosure relates to the technical field of materials, and specifically relates to a preparation method and use of a novel copper-metal organic framework (Cu-MOF)-derived magnetic Fe₃O₄@Cu/C composite.

### BACKGROUND

At present, due to the lack of reasonable treatment mechanisms and strict control measures, the continuous exposure of antibiotics in water bodies has caused many adverse effects on human health and ecosystems. As a preventive antibiotic, oxytetracycline (OTC) is generally used in agricultural production processes such as aquaculture. Due to limited absorption by animals after ingestion, large amounts of OTC are excreted into the natural water environment through excretion. The OTC has chemical stability and biological resistance, such that conventional chlorination and biodegradation processes are difficult to effectively eliminate it, resulting in the continuous accumulation of OTC in the natural environment and causing adverse effect to environment. Therefore, effective removal of OTC from wastewater to reduce its residual in the environmental water bodies is an important demand in the field of environmental protection. Currently, sulfate radical-based advanced oxidation processes (SR-AOPs) are considered to be one of the effective technologies for removing OTC because of its rapid removal with high efficiency. Since activation ability of peroxymonosulfate (PMS) in the sulfate radical-based SR-AOPs processes is a main factor reflecting catalyst efficiency, metals or metal oxides with various structures, crystal sizes, and appearances are considered to be key motivating factors for wastewater treatment by the sulfate radical-based SR-AOPs processes. Among many metals or metal oxides, iron oxides are generally used as a heterogeneous Fenton-type catalyst due to their abundant resources, low cost, and non-toxicity. Common ferric oxide generally faces a limited catalytic ability due to the slow conversion rate of Fe(III) into Fe(II) and poor electrical conductivity. In view of this, there is an urgent need to improve the catalytic activity of iron-based catalysts for PMS activation.

### SUMMARY

In order to solve the above existing problems, the present disclosure provides a preparation method and use of a novel Cu-MOF-derived magnetic Fe₃O₄@Cu/C composite.

The objects of the present disclosure can be achieved by the following technical solutions:

The present disclosure provides a copper-metal organic framework (Cu-MOF) material with a novel structure, where the Cu-MOF material has unit cell parameters including: a=8.7292 Å, b=20.4196 Å, c=34.3986 Å, α=β=γ=90°, and V=6131.42 Å³, and belongs to an orthorhombic crystal system and a Pbca space group.

The present disclosure further provides a method for preparing the Cu-MOF material described above, including the following steps:
mixing tris(4-(4H-1,2,4-triazol-4-yl)phenyl)amine, copper acetate, 1,3,5-benzenetricarboxylic acid, water and alcohol at a temperature of 120° C. to 170° C. to obtain a system;
adjusting a pH value of the system to 5 to 7 to obtain a solution;
subjecting the solution to reaction in a reactor for 72 h to 96 h to obtain a reaction product; and
subjecting the reaction product to gradient cooling to a temperature of 70° C. to 90° C. and natural cooling to room temperature in sequence to obtain the Cu-MOF material.

In some embodiments, a molar ratio of the tris(4-(4H-1,2,4-triazol-4-yl)phenyl)amine, the copper acetate, and the 1,3,5-benzenetricarboxylic acid is in a range of 1:(1-5):(1-5).

In the method described above, the reaction is conducted at a temperature of 145° C. to 165° C.; the gradient cooling is conducted at a speed of 5° C./h to 10° C./h; and the alcohol is selected from the group consisting of methanol and ethanol.

The present disclosure further provides a method for preparing a novel magnetic Fe₃O₄@Cu/C composite, including the following steps:
mixing the Cu-MOF material described above with Fe₂O₃ in a hexagonal structure and grinding evenly to obtain a mixture, then transferring the mixture to a tubular furnace, and conducting calcination under an inert gas atmosphere to obtain the novel magnetic Fe₃O₄@Cu/C composite.

In the method for preparing the novel magnetic Fe₃O₄@Cu/C composite described above, a molar ratio of the Cu-MOF material to the Fe₂O₃ in the hexagonal structure is in a range of 1:(1-1.5), and the grinding is conducted for 2 h to 4 h; and

the calcination is conducted by programmed heating at a heating rate of 2° C./min to 3° C./min to a calcination temperature of 600° C. to 650° C. and holding at the calcination temperature for 2 h to 4 h, and then subjecting an obtained calcination product to natural cooling to room temperature.

The present disclosure further provides a Fe₃O₄@Cu/C composite, which is prepared by the method described above.

The present disclosure further provides use of the magnetic Fe₃O₄@Cu/C composite in antibiotic degradation.

In some embodiments, the magnetic Fe₃O₄@Cu/C composite cooperates with a persulfate as a catalyst for efficient degradation of an antibiotic pollutant in water.

In some embodiments, the persulfate is sodium peroxymonosulfate (PMS), and the PMS is added in an amount of 0.5 mmol/L to 1.5 mmol/L.

In some embodiments, the antibiotic is OTC, and the antibiotic degradation is conducted under a pH value of 3 to 11 at a temperature of 25° C. to 45° C. for 50 min to 60 min. The composite shows anti-interference when catalytically degrading the OTC, and could still maintain a desirable degradation performance in the presence of inorganic ions such as H₂PO₄⁻, NO₃⁻, Cl⁻, HCO₃⁻, and SO₄²⁻ as well as humic acid (HA) (FIG. 4).

Some embodiments of the present disclosure have the following beneficial effects:

In the present disclosure, the method for preparing the magnetic Fe₃O₄@Cu/C composite is simple and easy to implement. The composite has a high efficiency in degrading antibiotics. Moreover, the composite shows anti-interference when catalytically degrading the OTC, and could still maintain a desirable degradation performance in the presence of inorganic ions such as H₂PO₄⁻, NO₃⁻; Cl⁻, HCO₃⁻, and SO₄²⁻ as well as HA (FIG. 4).

### BRIEF DESCRIPTION OF THE DRAWINGS

FIG. 1 shows a coordination environment diagram of the novel Cu-MOF material in Example 1 of the present disclosure (where H atoms are omitted);

FIG. 2 shows a scanning electron microscopy (SEM) image of the hexagonal appearance of the magnetic Fe₃O₄@Cu/C composite in Example 1 of the present disclosure;

FIG. 3 shows a degradation rate of OTC catalytically degraded by the Fe₃O₄@Cu/C composite in Example 1 of the present disclosure;

FIG. 4 shows an anti-interference test when the Fe₃O₄@Cu/C composite degrades OTC in Example 1 of the present disclosure;

FIG. 5 shows a degradation rate of OTC catalytically degraded by the Fe₃O₄@Cu/C composite at different pH values in Example 1 of the present disclosure;

FIG. 6 shows a magnetic hysteresis loop of the magnetic Fe₃O₄@Cu/C composite in Example 1 of the present disclosure; and

FIG. 7 shows a recyclable test of the magnetic Fe₃O₄@Cu/C composite in Example 1 of the present disclosure.

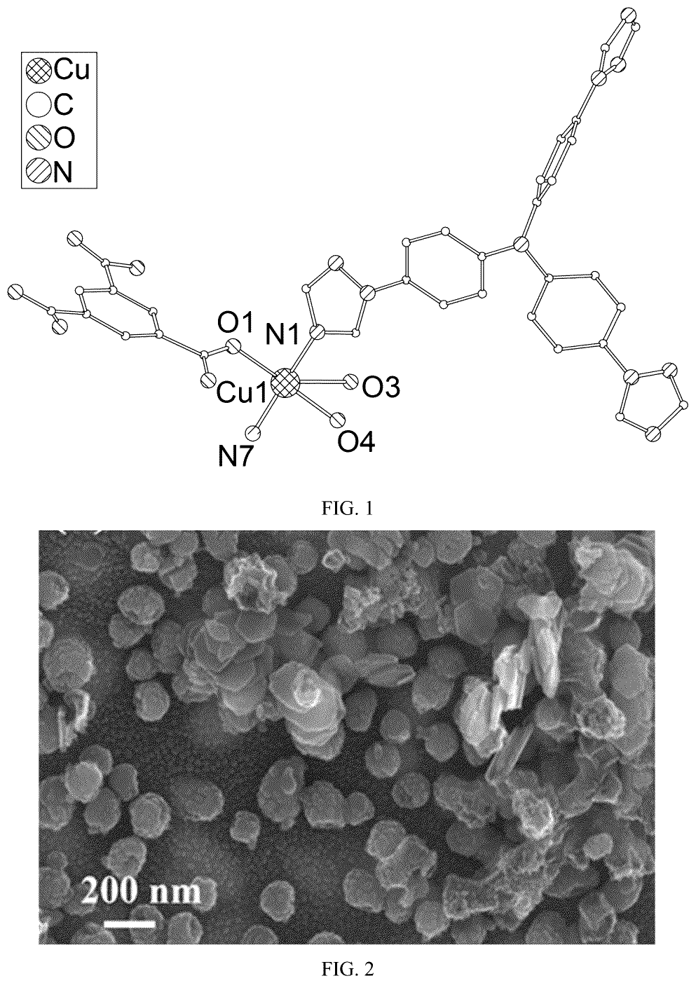

### DETAILED DESCRIPTION OF THE EMBODIMENTS

The present disclosure will be further described below in conjunction with examples, but the scope of the present disclosure is not limited thereto.

A method for preparing hexagonal Fe₂O₃ was performed by the following procedures:

1.0 mmol of FeCl₃·6H₂O was dissolved in 30 mL of ethanol, and 1 mL of water was added thereto; after complete dissolution, 0.8 g of sodium acetate was added, and then stirred vigorously for 1 h to obtain a solution. The solution was transferred to a polytetrafluoroethylene (PTFE) liner, heated to 180° C. for 12 h, and then cooled to room temperature to obtain a suspension. The suspension was centrifuged at a rotating speed of 10,000 rpm, and a resulting product was then washed repeatedly with water and ethanol, and dried in an oven at a temperature of 60° C. to obtain the hexagonal Fe₂O₃.

### Example 1

A magnetic Fe₃O₄@Cu/C composite was synthesized in two steps as follows:

### (1) Synthesis of Novel Cu-MOF Material

45.0 g (0.1 mol) of tris(4-(4H-1,2,4-triazol-4-yl)phenyl)amine, 42.1 g (0.2 mol) of 1,3,5-benzenetricarboxylic acid, and 57.5 g (0.3 mol) of copper acetate were added into a mixture of water and ethanol to obtain a reaction solution, where a mass of the water was 75 g (4.1 mol) and a mass of the methanol was 50 g (1.6 mol). A pH value of the reaction solution was adjusted to 6.5. A resulting solution was stirred for 15 min to obtain a mixed solution of reactants. The mixed solution was feed into a reactor, and crystallized at a temperature of 150° C. for 72 h to obtain a reaction product. After the reaction, the reaction product was subjected to gradient cooling at a speed of 10° C./h to a temperature of 80° C., then natural cooling to room temperature, and a resulting cooled product was filtered to obtain a blue transparent crystal, namely the novel Cu-MOF material. The blue transparent crystal was washed with a methanol solution until the surface of the crystal was free of impurities, and dried to obtain a compound with a novel structure. The obtained Cu-MOF material has a purity of 95% and a yield of 88%. According to results of the X-ray single crystal diffraction test, the crystal structure parameters of the Cu-MOF material show that its crystal system belongs to an orthorhombic crystal system and a Pbca space group. Specific unit cell parameters are: a=8.7292 Å, b=20.4196 Å, c=34.3986 Å, α=β=γ=90°, and V=6131.42 Å³. There are two-dimensional layered structural features in the crystal structure.

(2) Synthesis of Magnetic Fe₃O₄@Cu/C Composite

7.4 g (0.01 mol) of the Cu-MOF prepared in step (1) and 1.9 g (0.012 mol) of the hexagonal Fe₂O₃ were mixed, and ground for 2.5 h until the materials were evenly composited to obtain a composite Cu-MOF@Fe₂O₃. The composite Cu-MOF@Fe₂O₃ was transferred to a tubular furnace, and subjected to programmed calcination (the temperature was set to 600° C., and the heating rate was controlled to 2° C./h) under a nitrogen atmosphere for 3 h and then natural cooling to room temperature to obtain the novel magnetic Fe₃O₄@Cu/C composite. This composite could still maintain a hexagonal lamellar appearance and a large specific surface area, which are conducive to the dispersion of active sites during catalytic reactions (FIG. 2).

(3) Performance Test of Antibiotic Degradation by Magnetic Fe₃O₄@Cu/C Composite

### 1) Degradation Performance

The magnetic Fe₃O₄@Cu/C composite prepared in Example 1 was used to cooperatively excite PMS to degrade OTC, as follows:

5 mg of Fe₃O₄@Cu/C composite was weighed and placed in a 100 mL glass bottle, 50 mL of OTC (initial concentration was 20 mg/L) solution was added thereto, and the PMS was added thereto in an amount of 1 mmol/L. The degradation test was conducted in a constant-temperature water bath shaker at 180 rpm/min. At regular intervals, 2 mL of a reaction solution was taken and filtered with a 0.45 μm filter membrane, and quenched by 20 mM Na₂S₂O₃, where the test was conducted for 50 min. A concentration change of the reaction solution was measured with a UV-visible spectrophotometer. A degradation rate was calculated according to a formula c₀−c/c₀×100%, where c₀ and c are mass concentrations of the solution before and after degradation, respectively, in mg/L.

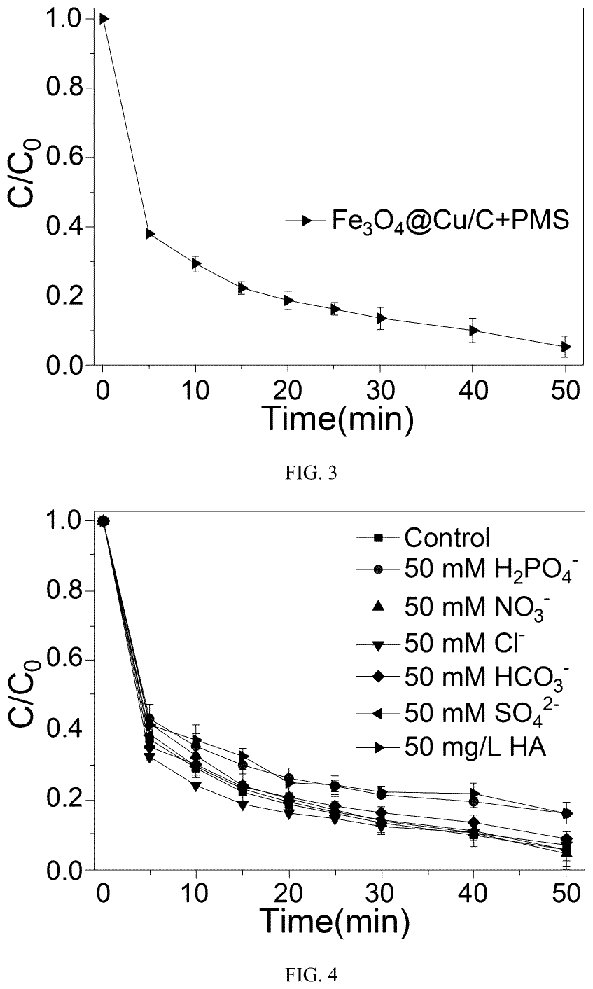

Under the condition that the composite prepared in Example 1 was used to degrade OTC, the degradation rate could reach 95% within 50 min (FIG. 3).

### 2) Anti-Interference Performance of the Composite

During the degradation performance test in 1), 50 mmol/L of interfering ions (H₂PO₄⁻, NO₃⁻, Cl⁻, HCO₃⁻; and SO₄²⁻) or 50 mg/L of humic acid were added. For OTC, the degradation efficiency only dropped by about 10%, proving that the composite has strong anti-interference ability (FIG. 4).

### 3) Applicable pH Range of the Composite

In the example of degrading OTC in 1), the pH value of the reaction system solution was adjusted to 3 to 11, and the Fe₃O₄@Cu/C composite could still exert a desirable catalytic degradation effect (FIG. 5).

### 4) Recovery and Recycling Performance of the Composite

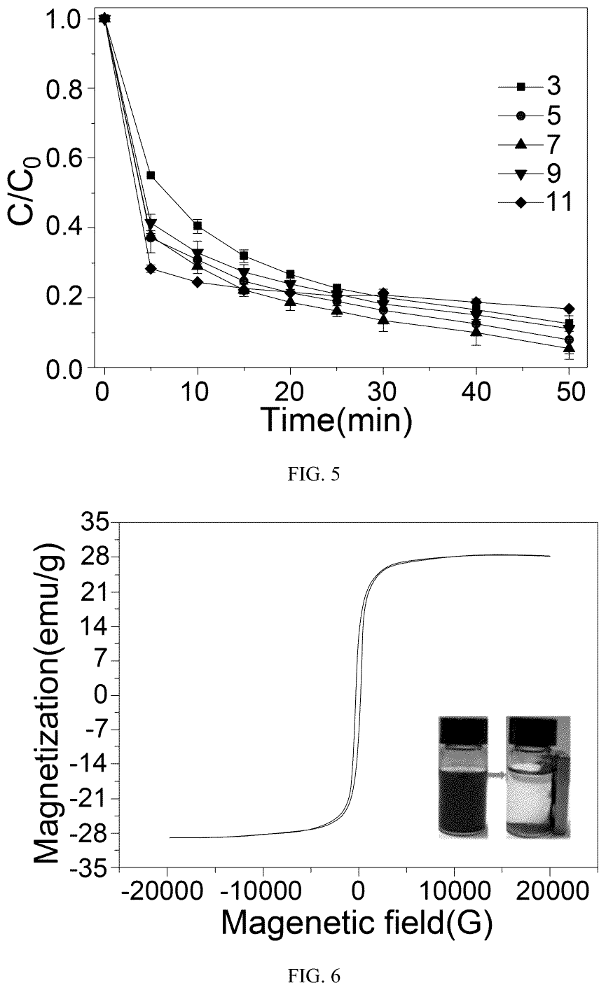

After each test run was completed, the Fe₃O₄@Cu/C composite was separated from the reaction solution using an external magnetic field (FIG. 6).

5) The composite recovered in 4) was cleaned and dried for 12 h for a recyclable test.

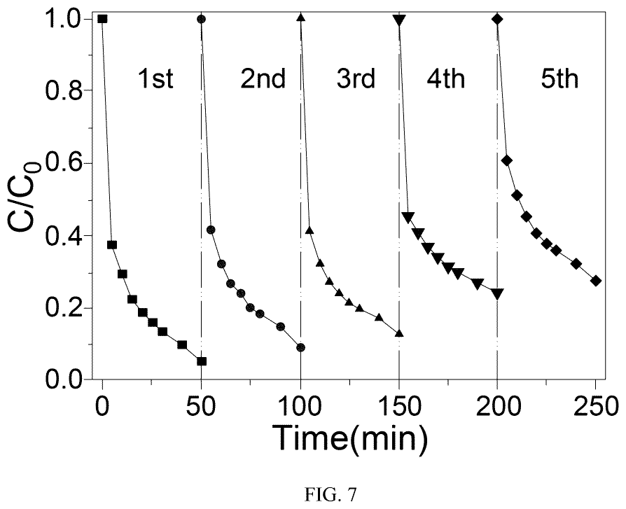

The composite was recycled 5 times, and its degradation rate of OTC could still reach 82% (FIG. 7).

What is claimed is:

1. A copper-metal organic framework (Cu-MOF) material, wherein the Cu-MOF material has unit cell parameters comprising: a=8.7292 Å, b=20.4196 Å, c=34.3986 Å, α=β=γ=90°, and V=6131.42 Å³, and belongs to an orthorhombic crystal system and a Pbca space group.

2. A method for preparing the Cu-MOF material of claim 1, comprising the following steps:
mixing tris(4-(4H-1,2,4-triazol-4-yl)phenyl)amine, copper acetate, 1,3,5-benzenetricarboxylic acid, water and alcohol at a temperature of 120° C. to 170° C. to obtain a system;
adjusting a pH value of the system to 5 to 7 to obtain a solution;
subjecting the solution to reaction in a reactor for 72 h to 96 h to obtain a reaction product; and
subjecting the reaction product to gradient cooling to a temperature of 70° C. to 90° C. and natural cooling to room temperature in sequence to obtain the Cu-MOF material;
wherein a molar ratio of the tris(4-(4H-1,2,4-triazol-4-yl)phenyl)amine, the copper acetate, and the 1,3,5-benzenetricarboxylic acid is in a range of 1:(1-5):(1-5).

3. The method of claim 2, wherein the reaction is conducted at a temperature of 145° C. to 165° C.; the gradient cooling is conducted at a speed of 5° C./h to 10° C./h; and the alcohol is selected from the group consisting of methanol and ethanol.

4. A method for preparing a magnetic Fe₃O₄@Cu/C composite, comprising the following steps:
mixing the Cu-MOF material of claim 1 with Fe₂O₃ in a hexagonal structure and grinding evenly to obtain a mixture, then transferring the mixture to a tubular furnace, and conducting calcination under an inert gas atmosphere to obtain the magnetic Fe₃O₄@Cu/C composite.

5. The method of claim 4, wherein a molar ratio of the Cu-MOF material to the Fe₂O₃ in the hexagonal structure is in a range of 1:(1-1.5), and the grinding is conducted for 2 h to 4 h; and
the calcination is conducted by programmed heating at a heating rate of 2° C./min to 3° C./min to a calcination temperature of 600° C. to 650° C. and holding at the calcination temperature for 2 h to 4 h, and then subjecting an obtained calcination product to natural cooling to room temperature.

6. A Fe₃O₄@Cu/C composite, which is prepared by the method of claim 4.

7. A method of using the magnetic Fe₃O₄@Cu/C composite prepared by the method of claim 4, comprising using the magnetic Fe₃O₄@Cu/C composite in antibiotic degradation.

8. The method of claim 7, wherein the magnetic Fe₃O₄@Cu/C composite cooperates with a persulfate as a catalyst for efficient degradation of an antibiotic pollutant in water.

9. The method of claim 8, wherein the persulfate is sodium peroxymonosulfate (PMS), and the PMS is added in an amount of 0.5 mmol/L to 1.5 mmol/L.

10. The method of claim 7, wherein an antibiotic is oxytetracycline (OTC), and the antibiotic degradation is conducted under a pH value of 3 to 11 at a temperature of 25° C. to 45° C. for 50 min to 60 min.
